(19) United States
(12) Patent Application Publication
(10) Pub. No.: US 2011/0180011 A1
(43) Pub. Date: Jul. 28, 2011

(54) CAGE STRUCTURE OF AN ENCLOSURE

(76) Inventor: Fu Chuan CHIU, Dapi Hsiang (TW)

(21) Appl. No.: 13/013,387

(22) Filed: Jan. 25, 2011

(30) Foreign Application Priority Data
Jan. 26, 2010 (TW) 099102165

(51) Int. Cl. A01K 1/03

(52) U.S. Cl. 119/452

(57) ABSTRACT

A cage structure of an enclosure includes two fence panels facing to each other, and two flat panels parallel with each other. Each fence panel includes an end rod are transversely fixed onto two ends thereof. One fence panel includes several end hooks at two ends thereof; the other fence panel includes several end hooks at one end and several retaining sections at the other end thereof. Each flat panel includes an end shaft are transversely fixed onto two ends thereof and a plurality of extension sections extend outwardly from two ends thereof. One end shaft of each flat panel is accepted in the end hooks of each end of one fence panel. The other end shaft of one flat panel is accepted in the end hooks of one end of the other fence panel; the other end shaft of the other flat panel is accepted in the end hooks of the other end of the other fence panel. Therefore, the two fence panels clasp with the two flat panels to serve as the cage structure.

### BACKGROUND OF THE INVENTION

1. Field of the Invention

The present invention relates generally to an enclosure, and more particularly to a cage structure, which is capable of fast assembly just by clasping two fence panels with two flat panels for highly convenience.

2. Description of the Related Art

To accomplish the assembly of the conventional cage, screw members, clips or wires are usually applied to the joint line of two mesh parts for connecting them together. It takes more time and more jobs to assemble or disassemble the conventional cage, such as tightening or loosing the screw members or the components the like. Besides, the most conventional cage is hard to disassemble to pieces after accomplishment of the assembly.

Furthermore, most screw members are usually too tiny to keep stored. If the screw members go lost, it would get trouble to reconnect parts of the cage. If the wires are applied thereto, it would look less tidy and stable substantially.

### SUMMARY OF THE INVENTION

It is therefore a primary object of the present invention to provide a cage structure of an enclosure, which is benefit of simple structure and highly convenience, by clasping the fence panels with the adjacent flat panels to accomplish the assembly thereof.

It is therefore a respective object of the present invention to provide a cage structure of an enclosure, which is capable of fast assembly and disassembly.

It is therefore a respective object of the present invention to provide a cage structure of an enclosure, which is easily stored and delivered.

To achieve the above object, a cage structure of an enclosure is offered. The cage structure includes a first fence panel and a second fence panel facing to each other, and a first flat panel and a second flat panel being parallel with each other and joining with two ends of the first and second fence panels.

The first fence panel includes a first main member, two first end rods and a plurality of first end hooks, the two first end rods are transversely fixed onto two ends of the first main member; the first end hooks curve inwardly from two ends of the first main member.

Each of the first end hooks defines a first U-shaped portion; a first holding portion is left in each of the first U-shaped portions after each of the first end rods is arranged through the respective first U-shaped portions.

The second fence panel includes a second main member, two second end rods, a plurality of second end hooks and a plurality of retaining sections. The two second end rods are transversely fixed onto two ends of the second main member; the second end hooks curve inwardly from one end of the second main member; the retaining sections extend inwardly from the other end of the second main member and are approximately vertical to the second main member.

Each of the second end hooks defines a second U-shaped portion. A second holding portion is left in each of the second U-shaped portions after one of the second end rods is arranged through the respective second U-shaped portions. A retaining portion is left under each of the retaining sections after the other of the second end rods is arranged under the respective second U-shaped portions.

The first and second flat panels have a base member, two end shafts and a plurality of extension sections; the two end shafts are transversely fixed onto two ends of each of the base members; the extension sections extend outwardly from two ends of each of the base members and are approximately parallel with the base members.

One end shaft of the first flat panel and one end shaft of the second flat panel are accepted in the first holding portions of the two ends of the first fence panel. The extension sections of one end of the first flat panel and one end of the second flat panel abut against the two first end rods of the first fence panel respectively.

The other end shaft of the first flat panel is accepted in the second holding portions of the second fence panel; the other end shaft of the second flat panel is kept by the retaining portion of the second fence panel and abuts against the retaining sections. The extension sections of the other end of the first flat panel and the other end of the second flat panel abut against the two second end rods of the second fence panel respectively.

Therefore, the first and second fence panels clasp with the first and second flat panels for connection to serve as the cage structure, which defines at least a top face, a bottom face, two side faces, a front end and a rear end.

As for the clasp capability of the cage structure, there is no need to use unnecessary components applied to the cage structure while engaging the two flat panels to the two fence panels. It would easily meet the requirements of fast assembly and disassembly. In addition, the configuration of the flat panel looks like that of the fence panel, so that the flat panel and fence panel are able to pile together for storage and very benefit to delivery.

The present invention can be best understood through the following description and accompanying drawings, wherein:

### BRIEF DESCRIPTION OF THE DRAWINGS

FIG. 1 is a perspective view illustrating a cage structure of an enclosure according to a first preferable embodiment of the present invention;

FIG. 2 is a perspective explosion view according to FIG. 1;

FIG. 3 is a side view according to FIG. 1;

FIG. 4 is a side view illustrating a first flat panel being clasping onto the a first fence panel according to the present invention;

FIG. 5 is a side view illustrating a first flat panel clasped onto the a first fence panel as a semi-finished product according to the present invention;

FIG. 6 is a side view illustrating a second flat panel being clasping onto the a semi-finished product in FIG. 5 according to the present invention;

FIG. 7 is a perspective view illustrating the cage structure of the enclosure according to a second preferable embodiment of the present invention;

FIG. 8 is a perspective view illustrating the cage structure of the enclosure according to a third preferable embodiment of the present invention;

FIG. 9 is a side view illustrating a resilient clip according to FIG. 8; and

FIG. 10 is a side view illustrating a clasping member according to FIG. 8.

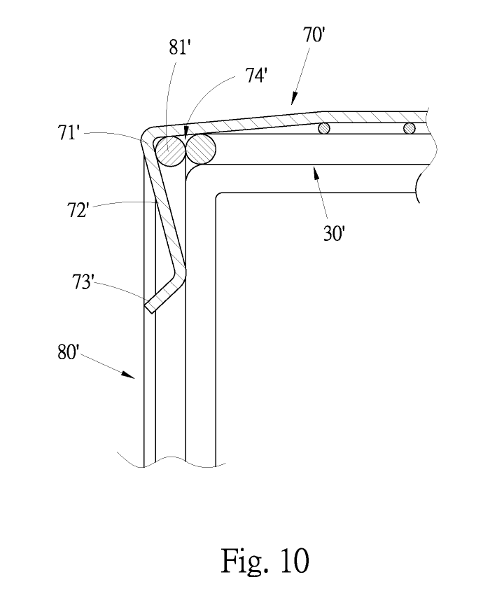

### DETAILED DESCRIPTION OF THE PREFERRED EMBODIMENTS

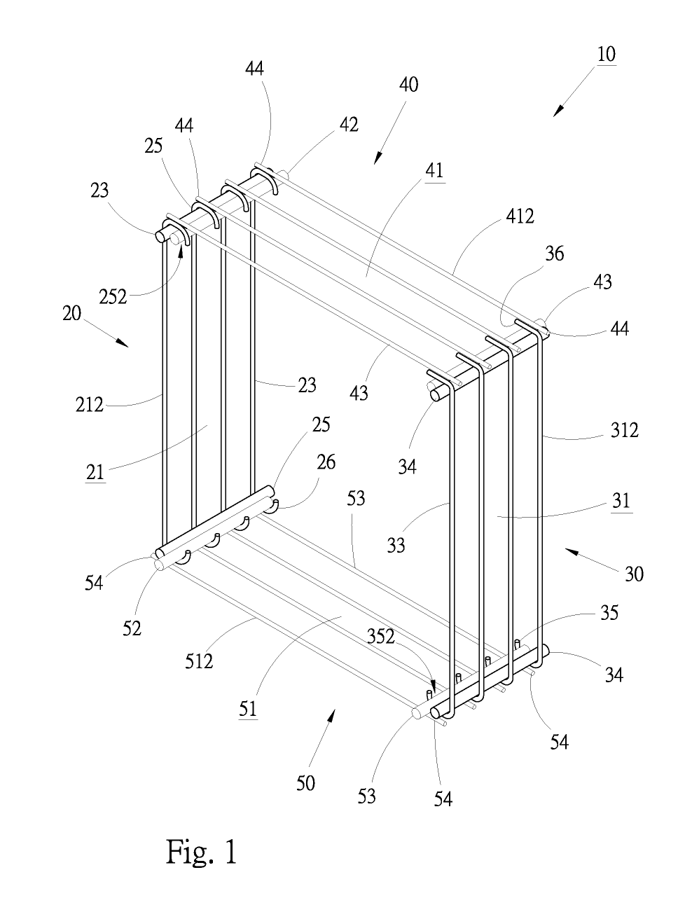

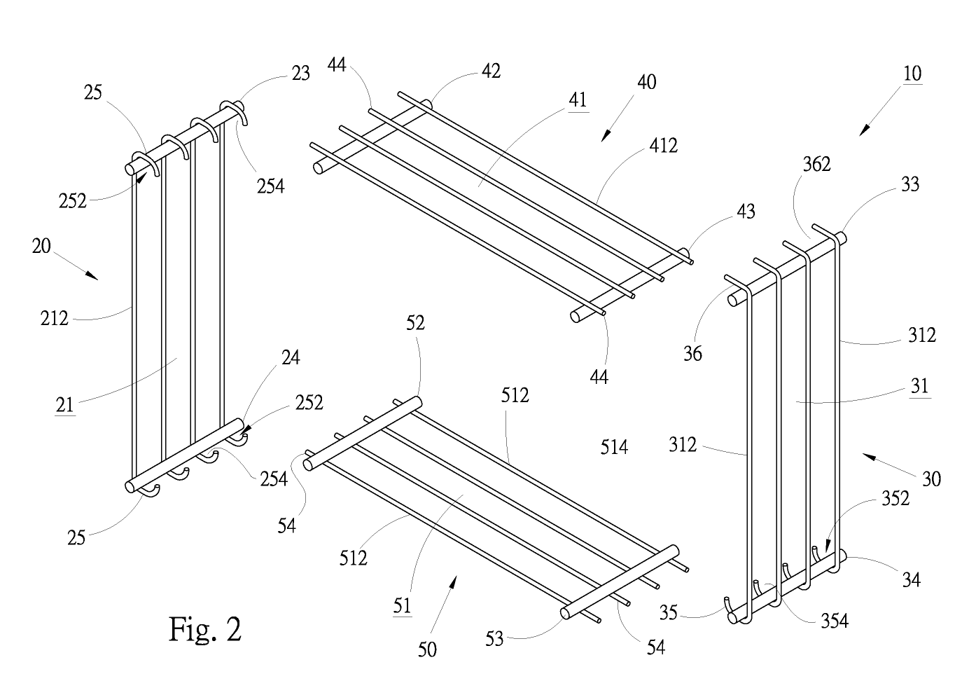

Please refer to FIGS. 1 and 2. According to a first preferred embodiment of the present invention, a cage structure 10 of an enclosure is disclosed. The cage structure 10 includes a first fence panel 20 and a second fence panel 30 facing to each other, and a first flat panel 40 and a second flat panel 50 paralleled with each other. The measurement size of the cage structure 10 is not restrained by the description of the embodiments.

The first fence panel 20 includes a first main member 21, two first end rods 23, 24, and a plurality of first end hooks 25. The two first end rods 23, 24 are transversely fixed onto two ends of the first main member 21. The first end hooks 25 curve inwardly from two ends of the first main member 21. Each of the first end hooks 25 defines a first U-shaped portion 252. A first holding portion 254 is left in each of the first U-shaped portions 252 after each of the first end rods 23, 24 is arranged through the respective first U-shaped portions 252.

The second fence panel 30 includes a second main member 31, two second end rods 33, 34, a plurality of second end hooks 35 and a plurality of retaining sections 36. The two second end rods 33, 34 are transversely fixed onto two ends of the second main member 31. The second end hooks 35 curve inwardly from one end of the second main member 31; the retaining sections 36 extend inwardly from the other end of the second main member 31 and are approximately vertical to the second main member 31. Each of the second end hooks 35 defines a second U-shaped portion 352. A second holding portion 354 is left in each of the second U-shaped portions 352 after one second end rod 34 is arranged through the respective second U-shaped portions 352. A retaining portion 362 is left under each of the retaining sections 36 after the other second end rod 33 is arranged under the respective retaining sections 36.

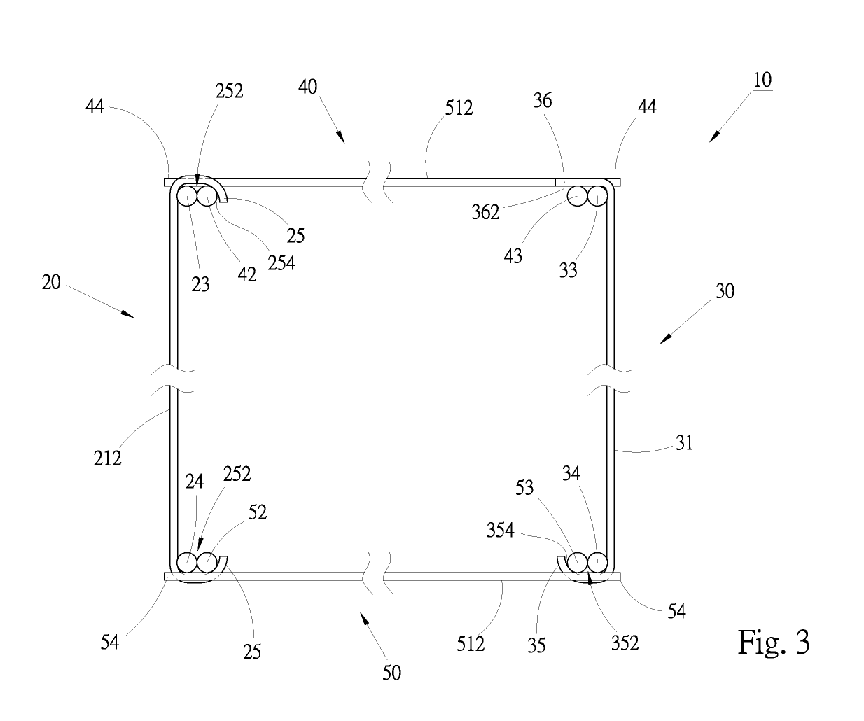

The first main member 21 of the first fence panel 20 could be a mesh panel, as illustrated in this preferred embodiment, and include a plurality of posts 212 paralleled with each other and at least jointed together by the two end rods 23, 24. The posts 212 each defines two ends. Two ends of each post 212 are bended to form the first end hook 25 with a first U-shaped portion 252, which has opening facing an interior of the cage structure 10. The first end hooks 25 are arranged at the same face of the first fence panel 20. With respect to FIG. 3, the two end rods 23, 24 are arranged transversely through the first U-shaped portions 252 of the first end hooks 25 respectively. After the two end rods 23, 24 are installed into the first end hooks 25 of the first fence panel 20, a gap is still left to form the first holding portion 254 in each first U-shaped portion 252.

The second main member 31 of the second fence panel 30 could be also a mesh panel, as illustrated in this preferred embodiment, and include a plurality of posts 312 paralleled with each other and at least jointed together by the two end rods 33, 34. The configuration of the second fence panel 30 is similar to that of the first one 20. The posts 312 each defines two ends. One end of each post 312 is bended to form the second end hook 35 with a second U-shaped portion 352, which having opening facing an interior of the cage structure 10. The other end of each post 312 extends inwardly to form the retaining section 36, which has an angle diverging approximately vertical to the second main member 31. The angle ranges from 80 to 90 degree, and appropriately is 85 degree. The second end hooks 35 and the retaining section 36 are arranged at the same face of the second fence panel 20. The end rod 33 is arranged transversely through the second U-shaped portions 352 of the second end hooks 35. After the end rod 33 is installed into the second end hooks 35 of the second fence panel 30, a gap is still left to form the second holding portion 354 in each second U-shaped portion 352. At the same time, the other second end rod 35 is arranged under the retaining sections 36, and a space is formed to define the retaining portion 362 under each retaining section 36.

The first and second flat panels 40, 50 have a base member 41, 51, two end shafts 42, 43 52, 53, and a plurality of extension sections 44, 54. Each base member 41, 51 includes a plurality of posts 412, 512. Each two end shafts 42, 43 52, 53 are transversely fixed onto two ends of each base member 41, 51. The extension sections 44, 54 extend outwardly from two ends of each base member 41, 51, are approximately parallel with the base members 41, 52, and further stretching over each two end shafts 42, 43 52, 53.

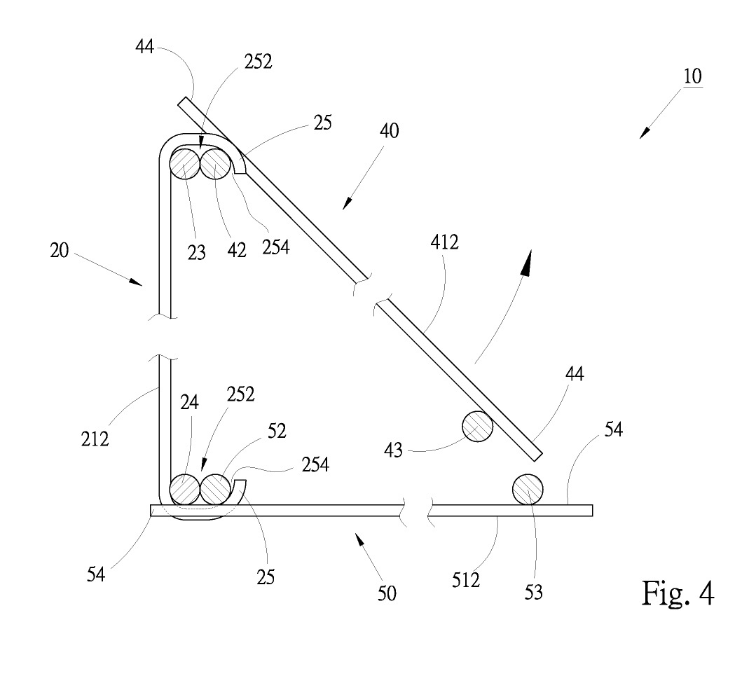

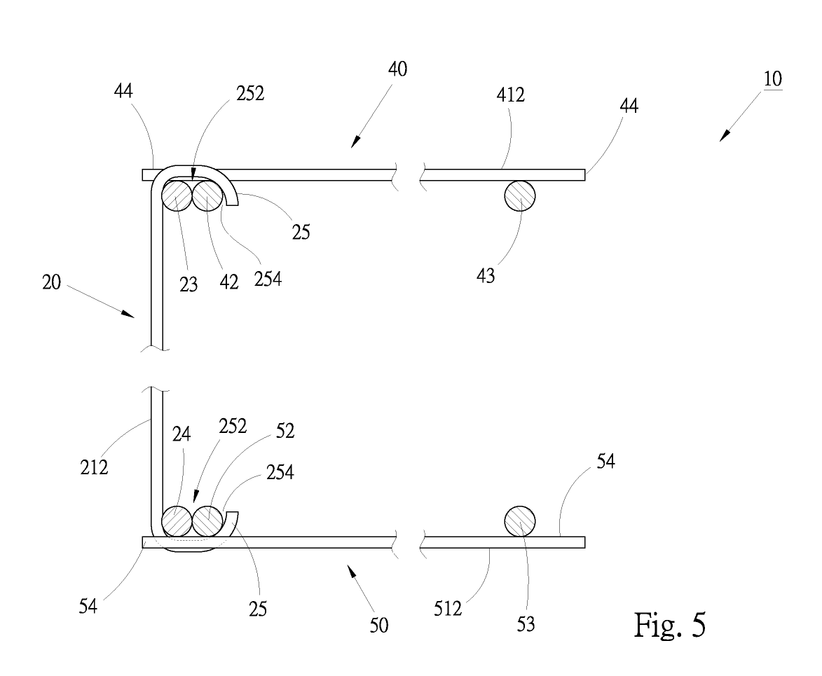

Referring to FIG. 4, to assemble the cage structure 10 is manipulated. The first flat panel 40 being clasping onto the first fence panel 20 is illustrated. To incline the first flat panel 40 inwardly is made for inserting one end shaft 42 into the first holding portions 254 of the first fence panel 20. Each holding portion 254 defines width, which is equivalent to a diameter of the end shaft 42 in order to allow the end shaft 42 rotate inside each holding portion 254 without leaving redundant space. Referring to FIG. 1, the extension sections 44 are preferably short-pole liked and stretching outwardly from two ends of each post 412 of the first flat panel 40. The extension sections 44 are staggered with the first end hooks 25. After that, the end shaft 42 is treated as a rotation axle for the first flat panel 40, and the first flat panel 40 turns upwards, singed as an arrow, until the first flat panel 40 is in a horizontal plane. At that time, the extension sections 44 abut against the end rod 23 of the first fence panel 20 so as to clasp the first flat panel 40 to the first fence panel 20, shown in FIG. 5.

Because the end shaft 42 of the first flat panel 40 tightly engages in the first holding portions 254 to prevent from slide and move, the end shaft 42 of the first flat panel 40 is ensured to join to the first end hooks 25 of the first fence panel 20. In addition, the extension sections 44 are designed to be against the end rod 23 of the first fence panel 20 for avoiding the first flat panel 40 over rotating. The end shaft 43 of the first flat panel 40 is thereby restrained by the end hooks 25 of the first fence panel 20. Comparatively, the extension sections 44 are forcing downwards and against the first end rod 23, and the first end rod 23 and the end shaft 42 are used to support an interior face of the first flat panel 40.

The second flat panel 50 is assembled to the other end of the first fence panel 20 in the same manner, which is to incline the second flat panel 50 inwardly in order to insert the end shaft 52 into the first holding portions 254 of the other end of the first fence panel 20. Each first holding portion 254 defines width, which is appropriately equivalent to a diameter of the end shaft 52, so that there is no redundant space after the end shaft 52 stays in the holding portions 254 and just is allowable to rotate inside the holding portions 254. Further rotating the second flat panel 50 downwardly to ensure to secure in the first end hooks 25 of the other end of the first fence panel 20, the extension sections 54 are against the first end rod 24 of the other end of the first fence panel 20 to secure the second flat panel 50.

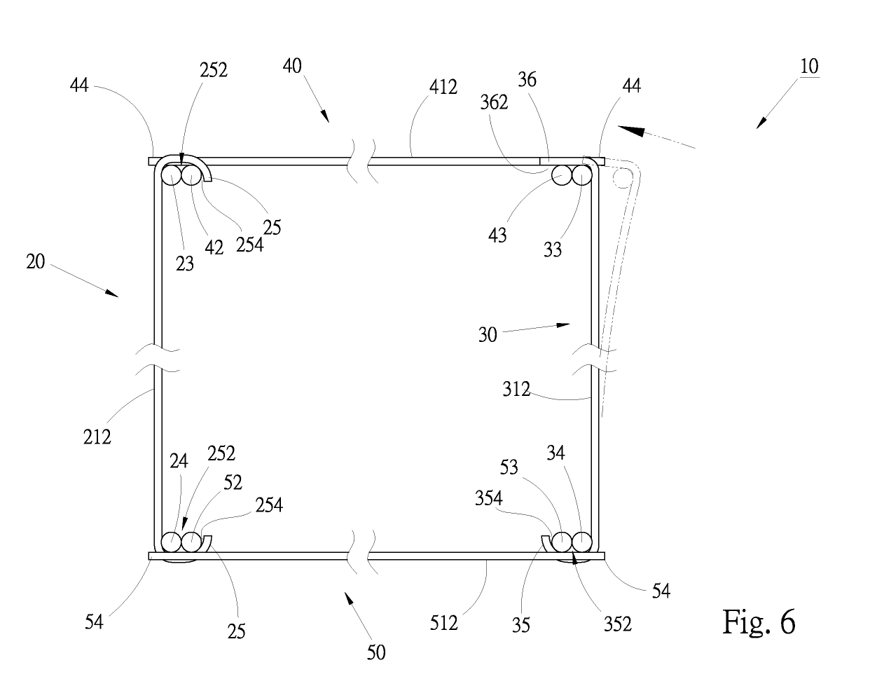

After the first fence panel 20 assembling to one end of each flat panel 40, 50, the second fence panel 30 is later applied to assemble with the other end of each flat panel 40, 50. With respect to FIG. 6, one end of the second fence panel 30 is connected to the other end of the second flat panel 50 by inserting the end shaft 53 of the second flat panel 50 into the second holding portions 354 of the second fence panel 30. As the second fence panel 30 connects to the other end of the second flat panel 50, the extension sections 54 of the second flat panel 50 are against the end rod 34 of the second fence panel 30 to ensure the assembly of the second flat panel 50 and the second fence panel 30. After that, the retaining sections 36 of the second fence panel 30 could be pulled slightly, the second fence panel 30 deflects slightly due to the flexibility per se, and the retaining sections 36 are forced towards the first flat panel 40, as signed the arrow in FIG. 6, in order to further engage with the end shaft 43 of the first flat panel 40. At that time, the extension sections 44 of the first flat panel 40 are against the second end rod 33 of the second fence panel 30, and the final assembly is illustrated as in FIG. 1.

The cage structure 10 according to the present invention is obtained by the end shafts 42, 52, 53 of the first and second flat panels 40, 50 inserting into the holding portions 254, 345 of the first and second fence panels 20, 30, and further by the end shaft 43 of the first flat panel 40 arranging at the retaining portions 362 of the second fence panel 30. The first and second flat panels 40, 50 clasp with the first and second fence panels 20. 30 thereby for accomplishing the assembly of the cage structure 10. At the same time, the extension sections 44, 54 of the first and second flat panels 40, 50 are against the end rods 23, 24, 33, 34 of the first and second fence panels 20, 30, so as to ensure the first and second flat panels 40, 50 engage with the first and second fence panels 20, 30 for preventing from slanting and swinging due to the instability per se.

Three end shafts 42, 52, 53 of the two flat panels 40, 50 are engaged by the end hooks 25, 35 of the two fence panels 20, 30; the other end shaft 43 is suppressed by the retaining sections 36. There is no need to apply redundant components, such as screw members or the like, to the cage structure 10, so that the trouble of component lost could be avoided. Fast assembly and disassembly are achieved thereby.

After accomplishing the assembly, the cage structure 10 thereby defines a top face, a bottom face, two side faces, and a front and rear ends. there is no restriction on the arrangement of these parts of case structure 10, which means the first and second flat panels 40, 50 are unnecessary to be the top and bottom faces thereof, the first and second flat panels 20, 30 are also unnecessary to be the two side faces.

The two ends of the cage structure 10 could be further installed another panel or door as the enclosure.

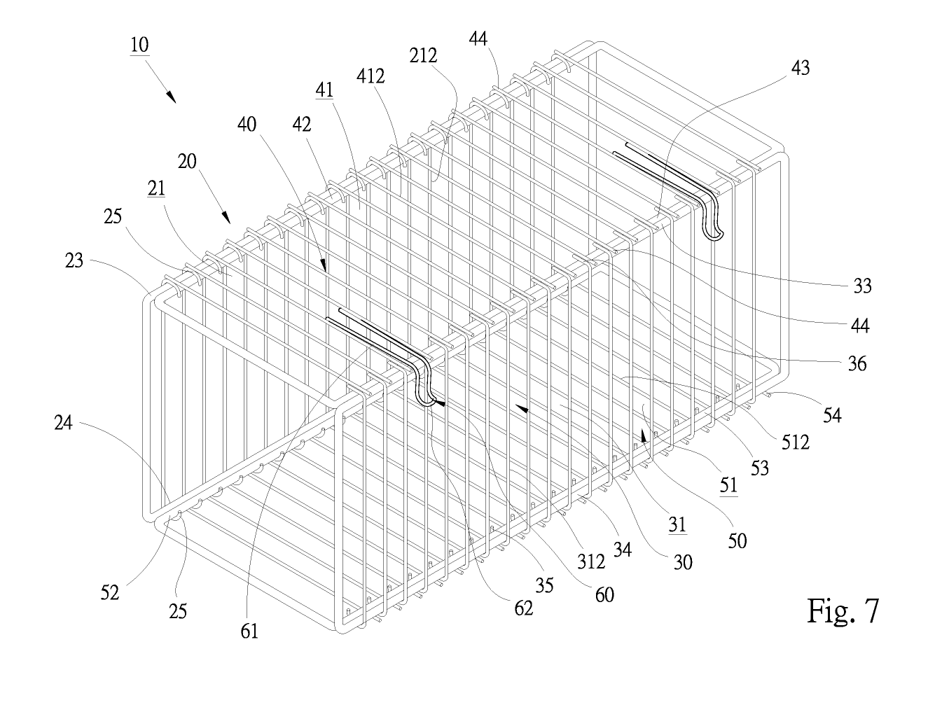

With respect to FIG. 7, the cage structure 10 according to the second preferred embodiment of the present invention further includes a plurality of resilient clips 60 arranged over the first flat panel 40 and the second fence panel 30, and each resilient clip 60 is set between two adjacent retaining sections 36 for keeping the end shaft 43 of the first flat panel 40 and the second end rod 33 of the second fence panel 30 in position. In detail, each resilient clip 60 could extend from the first flat panel 40 towards the second fence panel 30 to abut against the second end rod 33 of the second fence panel 30, and the end shaft 43 of the first flat panel 40 is secured thereby.

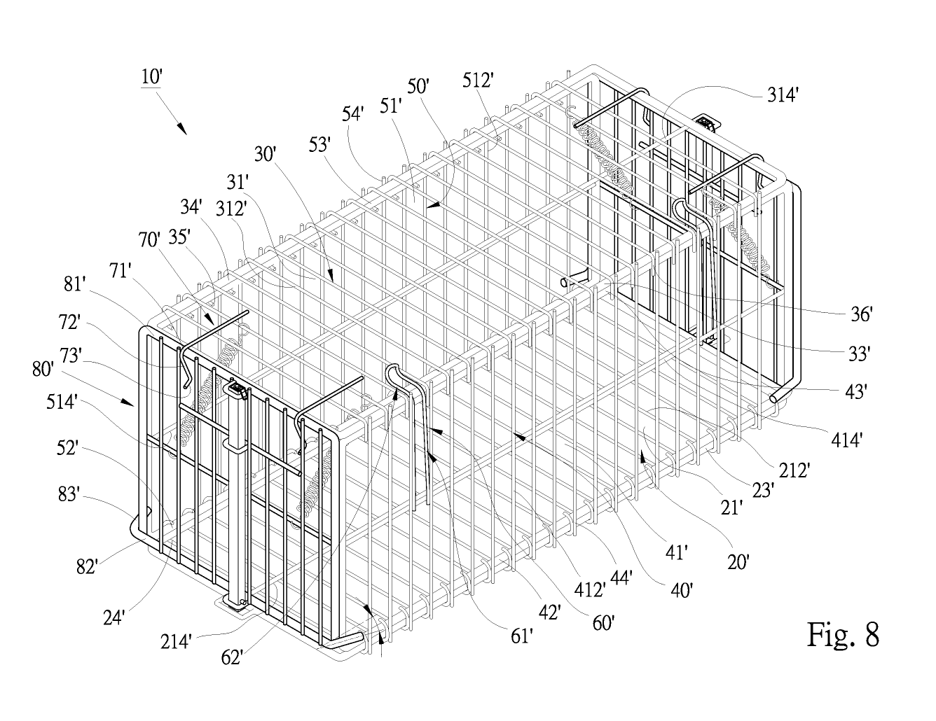

With respect to FIG. 8, the cage structure 10′ according to the third preferred embodiment of the present invention is implemented as same as the first preferred embodiment. The direction of the drawing in FIG. 8 is conversed by comparing with FIG. 1. The cage structure 10′ defines a top face, which is a second fence panel 30′, a bottom face, which is a first fence panel 20′, two side faces, which are first and second flat panels 40′ and 50′, and front and rear ends.

The cage structure 10′ includes the resilient clips 60′, which are as same as the resilient clips 60 in the second embodiment, extending from the first flat panel 40. Each resilient clip 60′ includes a resilient section 61′ for flexible manipulation and a clip section 62′. The resilient section 61′ is drawn outwardly from the base member 41′ of the first flat panel 40′. The clip section 62′ extends inwardly from the resilient section 61′ and is approximately vertical to the resilient section 61′; the clip section 61′ abuts against the second end rod 33′ of the second fence panel 30′ to restrain the end shaft 43′ of the first flat panel 40′.

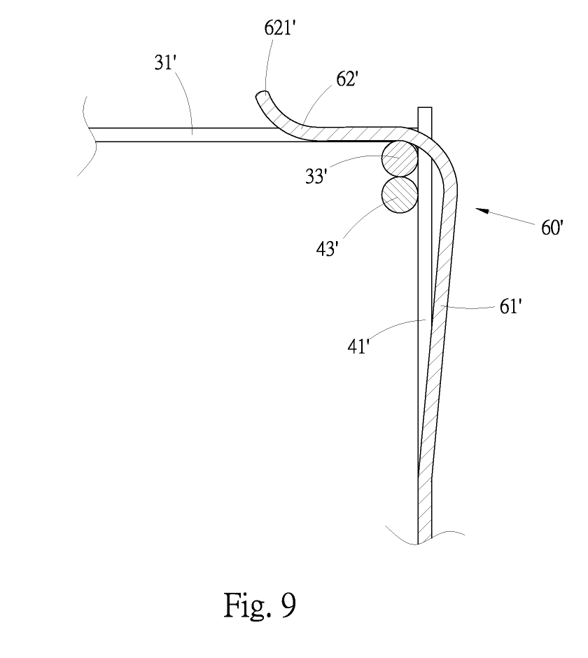

With respect to FIG. 9, each resilient section 61′ connects the base member 41′ of the first fence panel 40′ and diverges an angle θ from the plane of the base member 41′. The angle θ allows the resilient section 61′ swings flexibly. The clip section 62′ has a free end 621′ tilting outwards for offering easily manipulation. The user could press the resilient clip 60′ inwardly or push the resilient clip 60′ away from the cage structure.

The first and second main members 21′, 31′ of the first and second fence panels 20′, 30′ and the base members 41′, 51′ of the first and second flat panels 40′, 50′ include several posts 212′, 312′, 412′, 512′ and at least one connection rod 214′, 314′, 414′, 514′ respectively joining the corresponding posts 212′, 312′, 412′, 512′ together. The connection rod 214′, 314′, 414′, 514′ is designed for strengthening the structure of the main members 21′, 31′ and the base members 41′, 51′ per se.

In addition, the cage structure 10′ further includes a plurality of clasping members 70′, and at least one cage door 80′ engaging to at least one end of the cage structure 10′ via the clasping members 70′. The clasping members 70′ are wave-liked and arranged to any face or at least one face; the clasping members 70′ extend from exterior side of the face. Each clasping member 70′ defines includes an engagement portion 71′ and a guiding portion 72′. The engagement portion 71′ bends from the cage structure 10′ with an inclined angle towards the cage door 80′; the guiding portion 72′ is arranged at an inner side of cage door 80′ and smoothly connected to the engagement portion 71′. The clasping member 70′ further includes an orientating portion 73′ extending outwardly from the guiding portion 72′ and towards an outer side of the cage door 80′. A pivotal space 74′, distancing from the cage structure 10′, is formed between the engagement portion 71′ and cage structure 10′. A top shaft 81′ of the cage door 60′ slides along the guiding portion 72′ to the engagement portion 71′ to be received in the pivotal space 74′ for joining the cage door 80′ to the cage structure 10′. The measurement sizes of the orientating portions 73′ are not restrained. The orientating portions 73′ could not only stay at the inner side of the cage door 80′ but also stay at outer side of the cage door 80′. The orientating portion 73′ diverges an angle from the guiding portion 72′ is at least more than 90 degree.

Referring to FIG. 8, the cage door 80′ includes two lateral guides 83′ extending from a bottom shaft 82′ thereof, an angle δ is defined by diverging from each lateral guide 83′ to the each side face of the cage structure 10′, so as to ensure the lateral guides 83′ simultaneously touch the two side faces of the cage structure 10′ for the cage door 80′ symmetrically attaching to the cage structure 10′.

As for the clasp capability of the cage structure, there is no need to use unnecessary components applied to the cage structure while engaging the two flat panels to the two fence panels. It would easily meet the requirements of fast assembly and disassembly. In addition, designs of the resilient clips provide highly stability of the cage structure.

The cage structure is flexible to combine cage door to meet various requests.

In addition, the configuration of the flat panel looks like that of the fence panel, so that the flat panel and fence panel are able to pile together for storage and very benefit to delivery.

The above embodiments are only used to illustrate the present invention, not intended to limit the scope thereof. Many modifications of the above embodiments can be made without departing from the spirit of the present invention.

What is claimed is:

1. A cage structure of an enclosure, comprising:
a first fence panel and a second fence panel, facing to each other;
wherein the first fence panel includes a first main member, two first end rods and a plurality of first end hooks, the two first end rods are transversely fixed onto two ends of the first main member; the first end hooks curve inwardly from two ends of the first main member;
wherein each of the first end hooks defines a first U-shaped portion; a first holding portion is left in each of the first U-shaped portions after each of the first end rods is arranged through the respective first U-shaped portions;
wherein the second fence panel includes a second main member, two second end rods, a plurality of second end hooks and a plurality of retaining sections, the two second end rods are transversely fixed onto two ends of the second main member; the second end hooks curve inwardly from one end of the second main member; the retaining sections extend inwardly from the other end of the second main member and are approximately vertical to the second main member;
wherein each of the second end hooks defines a second U-shaped portion; a second holding portion is left in each of the second U-shaped portions after one of the second end rods is arranged through the respective second U-shaped portions; a retaining portion is left under each of the retaining sections after the other of the second end rods is arranged under the respective retaining sections; and
a first flat panel and a second flat panel, being parallel with each other and joining with two ends of the first and second fence panels; the first and second flat panels have a base member, two end shafts and a plurality of extension sections; the two end shafts are transversely fixed onto two ends of each of the base members; the extension sections extend outwardly from two ends of each of the base members and are approximately parallel with the base members;
wherein one end shaft of the first flat panel and one end shaft of the second flat panel are accepted in the first holding portions of the two ends of the first fence panel; the extension sections of one end of the first flat panel and one end of the second flat panel abut against the two first end rods of the first fence panel respectively;
wherein the other end shaft of the first flat panel is accepted in the second holding portions of the second fence panel; the other end shaft of the second flat panel is kept by the retaining portion of the second fence panel and abuts against the retaining sections; the extension sections of the other end of the first flat panel, and the other end of the second flat panel abut against the two second end rods of the second fence panel respectively;
whereby the first and second fence panels clasp with the first and second flat panels for connection to serve as the cage structure, which defines at least a top face, a bottom face, two side faces, a front end and a rear end.

2. The cage structure of the enclosure according to claim 1, wherein the second main member defines an angel diverging to the retaining sections, and the angle appropriately ranges from 80 to 90 degree.

3. The cage structure of the enclosure according to claim 1, wherein each holding portion defines width, which is equivalent to a diameter of the end shaft.

4. The cage structure of the enclosure according to claim 1, wherein the base member of each flat panel and the main member of each fence panel include a plurality of posts parallel with each other.

5. The cage structure of the enclosure according to claim 4, wherein the extension sections are short-pole liked and stretching outwardly from two ends of each post.

6. The cage structure of the enclosure according to claim 1, further including a plurality of resilient clips arranged over the first flat panel and the second fence panel; each resilient clip is set between two adjacent retaining sections for keeping the end shaft of the first flat panel and the second end rod of the second fence panel in position.

7. The cage structure of the enclosure according to claim 6, wherein each resilient clip includes a resilient section for flexible manipulation and a clip section, and the clip section extends inwardly from the resilient section and is approximately vertical to the resilient section.

8. The cage structure of the enclosure according to claim 1, wherein the resilient section is drawn outwardly from the base member of the first flat panel, the clip section abut against the second end rod of the second fence panel to restrain the end shaft of the first flat panel.

9. The cage structure of the enclosure according to claim 6, wherein the second base member defines an angel diverging to the retaining sections, and the angle appropriately ranges from 80 to 90 degree.

10. The cage structure of the enclosure according to claim 1, further including a plurality of clasping members, and at least one cage door engaging to at least one end of the cage structure via the clasping members; wherein each clasping member defines a pivotal space, distancing from the cage structure, to accept a top shaft of the cage door for joining the cage door to the cage structure.

11. The cage structure of the enclosure according to claim 10, wherein each clasping member includes an engagement portion and a guiding portion; the engagement portion bends from the cage structure with an inclined angle towards the cage door; the guiding portion is arranged at an inner side of cage door and smoothly connected to the engagement portion; the pivotal space is formed between the engagement portion and the guiding portion; whereby the top shaft of the cage door slides along the guiding portion to the engagement portion to be received in the pivotal space for joining the cage door to the cage structure.

12. The cage structure of the enclosure according to claim 11, wherein the clasping member further includes an orientating portion extending outwardly from the guiding portion and towards an outer side of the cage door.

13. The cage structure of the enclosure according to claim 10, wherein the cage door includes two lateral guides extending from a bottom shaft thereof, an angle is defined by diverging from each lateral guide to the each side face of the cage structure for the lateral guides simultaneously touching the two side faces.

14. The cage structure of the enclosure according to claim 11, wherein the cage door includes two lateral guides extending from a bottom shaft thereof, an angle is defined by diverging from each lateral guide to the each side face of the cage structure, so that the lateral guides simultaneously touch the two side faces of the cage structure

15. The cage structure of the enclosure according to claim 10, wherein the second base member defines an angel diverging to the retaining sections, and the angle appropriately ranges from 80 to 90 degree.

16. The cage structure of the enclosure according to claim 6, further including a plurality of clasping members, and at least one cage door engaging to at least one end of the cage structure via the clasping members; wherein each clasping member defines a pivotal space, distancing from the cage structure, to accept a top shaft of the cage door for joining the cage door to the cage structure.

17. The cage structure of the enclosure according to claim 16, wherein each clasping member includes an engagement portion and a guiding portion; the engagement portion bends from the cage structure with an inclined angle towards the cage door; the guiding portion is arranged at an inner side of cage door and smoothly connected to the engagement portion; the pivotal space is formed between the engagement portion and the guiding portion; whereby the top shaft of the cage door slides along the guiding portion to the engagement portion to be received in the pivotal space for joining the cage door to the cage structure.

18. The cage structure of the enclosure according to claim 17, wherein the clasping member further includes an orientating portion extending outwardly from the guiding portion and towards an outer side of the cage door.

19. The cage structure of the enclosure according to claim 16, wherein the cage door includes two lateral guides extending from a bottom shaft thereof, an angle is defined by diverging from each lateral guide to the each side face of the cage structure, so that the lateral guides simultaneously touch the two side faces of the cage structure.

20. The cage structure of the enclosure according to claim 17, wherein the cage door includes two lateral guides extending from a bottom shaft thereof; an angle is defined by diverging from each lateral guide to the each side face of the cage structure, so that the lateral guides simultaneously touch the two side faces of the cage structure.
